(19) United States
(12) Patent Application Publication
(10) Pub. No.: US 2008/0155311 A1
(43) Pub. Date: Jun. 26, 2008

(54) TECHNIQUE FOR DETERMINING THE START POSITION TO WRITE DATA ON TAPE WITH RESISTANCE FOR MEDIA DEFECT

(75) Inventor: Yutaka Oishi, Kawasaki (JP)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/551,785

(22) Filed: Oct. 23, 2006

(51) Int. Cl. G06F 11/00

(52) U.S. Cl. 714/6

(57) ABSTRACT

An embodiment of the present invention is a method of computing the write start position of redundant data. In this regard, data integrity against a vertical defect in tape media can be increased when the encryption keys eHKDSr (reverse direction) and eHKDSf (forward direction) are written to the tape media between tape media sections LP2 and LP3 such that they do not overlap. To accomplish this the method stores in a memory a plurality of data related to the write start and write end position of the eHKDSr key after the eHKDSr key is written to the tape media. The write start position of the eHKDSf key is then dynamically calculated such that the eHKDSf key does not overlap the eHKDSr key. As such, a vertical defect in the tape media is less likely to damage both the eHKDSr and the eHKDSf keys.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a method of computing the write start position of redundant data, and particularly to increasing data integrity against a vertical defect in tape media by insuring the encryption keys eHKDSr (reverse direction) and eHKDSf (forward direction) are written to the tape media between sections LP2 and LP3 such that they do not overlap.

2. Description of Background

Before our invention when implementing a cipher function in an Enterprise Tape Drive system, such as the IBM System Storage TS1120 a key used for encrypting and decrypting data was written to the tape media. In this regard, a tape has the following addresses in the length direction: LP0, LP1, LP2, LP3, LP4, LP5, and LP6. Referring to prior art FIG. 1A there is illustrated tape media format 100. Shown is the relative location of the encryption key data.

When a dataset is to be written to the tape media a key associated with encryption is written to a section between LP2 and LP3. Such a key can be referred to as ‘eHKDS’. If the eHKDS is lost, the user data becomes unreadable or unwritable. Accordingly, the eHKDS is written into a plurality of areas. In this regard, the eHKDS that is written to the section between LP2 and LP3 in the forward direction is referred to as an ‘eHKDSf’ and the eHKDS that is written to the section between LP2 and LP3 in the backward or reverse direction is referred to as an ‘eHKDSr’.

The eHKDSf is written from a point in the section adjacent to LP2 whereas the eHKDSr is written from a point in the section adjacent to LP3. The length of the section is 230 LPOS (note that one LPOS=7.2 mm). The eHKDS can be written within a range of as small as several tens of LPOSs.

In order to prevent the eHKDSf and eHKDSr from being unreadable due to a defect of the tape in the vertical direction, initially, it was planned that the regions to which the eHKDSf and eHKDSr were to be written would be shifted in the length direction, as shown in prior art FIG. 1B, tape format 200 noting the safe gap added at LP3.

However, after the actual implementation and verification, it turns out that the reliability cannot be ensured if the eHKDS is written in the vicinity of LP3. This is due impart to the fact that the point LP4 is located on the right side, far from LP3. The normal data is read from and written to a section between LP3 and LP4. For example, when data is written to a region from LP4 to LP3 and the head reaches LP3, the tape is temporarily stopped in order to successively write the data. Subsequently, the remaining data is written to a region from LP3 to LP4. At that time, the head for reading and writing the data stops at a position at which the head slightly passes beyond LP3 to the side of LP2. Since the head is in contact with the tape, debris is sometimes left on the tape in the vicinity of the position at which the head stops. Accordingly, the performance of the read and write operation of data in the vicinity of LP3 between LP2 and LP3 deteriorates, and therefore, the reliability of the read and write operation cannot be ensured.

To address this issue, the safe-gap was set to 370 LPOS (as illustrated in prior art FIG. 1B). However, after verification, it turns out that the safe-gap having a length of 370 LPOS is not sufficient. Accordingly, it was determined that the eHKDSr area was located between the points LP2 and (LP2+230 LPOS) in the horizontal direction, which is the same area as the eHKDSf area (as illustrated in prior art FIG. 1A). Thus, the degradation of the reliability occurring when the data is written to an area in the vicinity of L3 (including the original eHKDSr area) cannot be prevented.

Also note that the length of each of the eHKDS areas cannot be decreased any more due to the specification of an ERP (error recovery procedure) used when each eHKDS is written. Although the length of normal user data is 555 LPOS per DS at maximum, the length of the eHKDS is 230 LPOS by cutting overhead. To avoid the eHKDS to be placed in the vicinity of LP3, the eHKDS areas should overlap. In addition, it was impractical to increase a safe-gap in the vicinity of LP3, since the area for the eHKDS is decreased from the current size.

Though, the areas for the eHKDSf and the eHKDSr overlap in the length direction, and the two regions are shifted towards LP2. As a result, the eHKDSf and eHKDSr can be written to regions with a high reliability. However, the following problem still remains: if a media defect of the tape in the vertical direction is generated, both eHKDSf and eHKDSr become unreadable.

There is a long felt need for a method of writing eHKDSf and eHKDSr to the media to improve the resistance to a media defect extending in the vertical direction.

### SUMMARY OF THE INVENTION

The shortcomings of the prior art are overcome and additional advantages are provided through the provision of a method of computing the write start position of redundant data, the method comprising writing a first eHKDS on a tape media between the tape media sections LP2 and LP3; storing in a memory a plurality of data related to the write start and write end position of the first eHKDS after the first eHKDS is written to the tape media; and calculating based on the plurality of data the write start position of a second eHKDS between the tape media sections LP2 and LP3, such that the second eHKDS does not overlap the first eHKDS, wherein a vertical defect in the tape media is less likely to damage both the first eHKDS and the second eHKDS.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution that increases data integrity against a vertical defect in tape media by insuring the encryption keys eHKDSr (reverse direction) and eHKDSf (forward direction) are written to the tape media between sections LP2 and LP3 such that they do not overlap.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1A illustrates one example of a prior art tape format 100 showing how eHKDSf, and eHKDSr key data was written to the tape media between area LP2 and LP3 implementing a long safe-gap area;

FIG. 1B illustrates one example of a prior art tape format 200 showing how eHKDSf, and eHKDSr key data was written to the tape media between area LP2 and LP3 implementing a safe-gap area;

FIG. 2 illustrates one example of a tape format 300 showing how eHKDSf, and eHKDSr key data is written to the tape media using the method of computing the write start position; and

FIG. 3 illustrates one example of a routine for writing a first eHKDS, and second eHKDS key data to tape media using a method of computing the write start position.

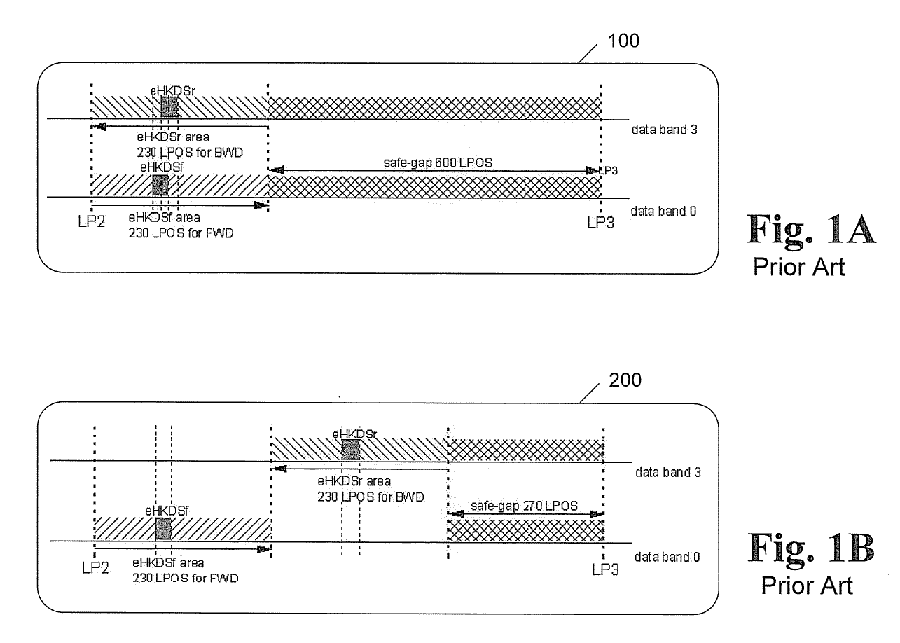

The detailed description explains the preferred embodiments of the invention, together with advantages and features, by way of example with reference to the drawings.

### DETAILED DESCRIPTION OF THE INVENTION

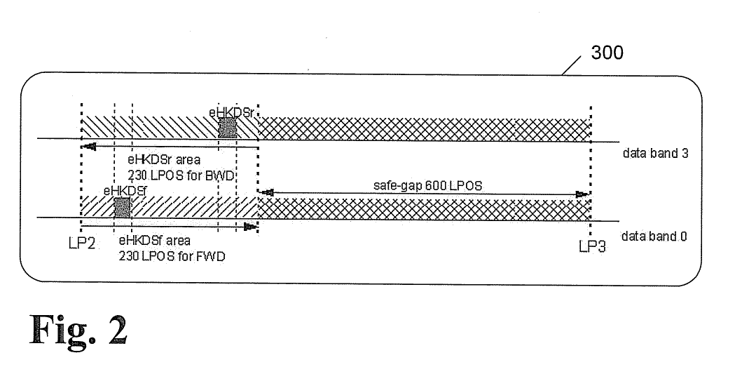

Turning now to the drawings in greater detail, it will be seen that in FIG. 2 there is illustrated one example of a tape format 300 showing how eHKDSf, and eHKDSr key data is written to the tape media using the method of computing the write start position.

In an exemplary embodiment, one of the eHKDSf or eHKDSr that is written first can be referred to as an ‘eHKDS1’ or first eHKDS whereas the other of the eHKDSf or eHKDSr that is written second can be referred to as an ‘eHKDS2’ or second eHKDS. When the eHKDS2 is written and the write start position is determined, the position of the eHKDS1 is referenced and the write start position is determined so that the eHKDS2 and the eHKDS1 do not overlap.

In general, in order to write a maximum amount of data to a tape, a tape drive scans the tape a few dozen times. One scan area is referred to as a ‘Wrap’. In general, when the tape drive determines the write start position, the tape drive does not take into consideration the presence of data written to another Wrap. This is because the consideration of all the data written to several tens of Wraps is impractical. However, unlike the normal case, in this case, since only two eHKDSs for encryption purpose are written to an area between LP2 and LP3, the write start position can be determined depending on the data written to another Wrap.

In addition, since only one eHKDS is written to each of the Wraps between LP2 and LP3, the recording density is not affected even when the write start position is shifted.

By using the position information about the eHKDS1 when the eHKDS2 is written to the tape the beginning position of the write can be determined as not to overlap eHKDS1. As such, the resistance to a media defect of the tape extending in the vertical direction can be increased with respect to data in the same area on different Wraps. One example of this formatting is illustrated in FIG. 2.

Since the eHKDSf and eHKDSr are successively written, the microcode can memorize the start position and the end position of each of the eHKDSf and eHKDSr. That is, this information can be stored in a memory in the tape drive or elsewhere as may be desired and or required.

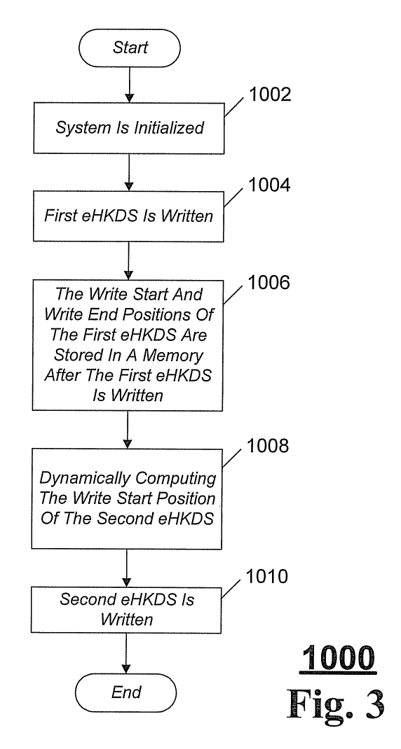

In an exemplary embodiment, when viewed from a software perspective, the method illustrated in FIG. 3 writes a first eHKDS, stores the write start and write end positions of the first eHKDS in a memory after the first eHKDS is written, the write start position of the second eHKDS is dynamically calculated on the basis of the positional information of first eHKDS, and the second eHKDS is written. In an exemplary embodiment, eHKDSr can be referred to as the first eHKDS, and eHKDSf can be referred to as the second eHKDS.

In an exemplary embodiment for example and not limitation, every time the eHKDSf or eHKDSr is written to the tape, the write start position of the eHKDSf or eHKDSr is also written to a nonvolatile memory called a ‘cartridge memory (CM)’ in a tape cartridge, although this feature is not essential for this implementation. The data stored in the CM can be used for reference.

In an exemplary embodiment for example and not limitation, the write start position of the redundant data is computed on the basis of the position of the data written first. In this regard, it is assumed that the eHKDSr is written first and, subsequently, the eHKDSf is written. The computational expression is as follows:

Let LP2 be the origin (i.e., zero). Let L denote the length of an area, s denote the maximum length of eHKDS, t denote the minimum length of eHKDS, α denote an appropriate number greater than or equal to zero (tolerance at the end of the area), x denote the write start position of eHKDSf (i.e., the value to be computed), n denote the number of retries of the write operation of the eHKDSf (note that n=1 for a first write operation), rc denote the type of error occurring during the write operation of the eHKDSf, g(rc) denote the distance between the current write position and the next write position when an error occurs during the write operation of the eHKDSf (note that g(rc) varies depending on the type of error), r1 denote the write end position of the eHKDSr, r2 denote the write start position of the eHKDSr (note that the relationship r1+t≦r2 is always satisfied since the eHKDSr is written from LP3 towards LP2), and z denote a minimum distance between the eHKDSf and eHKDSr.

(A) known computational expression f(n) for computing the write start position of the eHKDSf:
a) n=1 (i.e., first write operation)

x=f(n)=LP2=0
b) n≧2 and f(n−1)+t+α+g(rc)<L

x=f(n)=f(n−1)+g(rc)
c) n≧2 and f(n−1)+t+α+g(rc)≧L

x=f(n)=L−t−α

Note that a specific value is used in the vicinity of the end of the area.

(B) computational expression h( ) according to this embodiment
a) f(n)≦r2+z and r1≦f(n)+s+z and r2+z+α<L

x=h(f(n))=r2+z

Note that if there is a possibility that the eHKDSf overlaps the eHKDSr (the eHKDSf is too close to the eHKDSr), the eHKDSf jumps over the eHKDSr. Here, the distance may be changed to x=r2+z+g(rc) depending on an error occurring at the closest point. In such a case, the term g(rc) can inform the type of error by simply reading a group of fragments of the eHKDSr later.
b) f(n)≦r2+z and r1≦f(n)+s+z and r2+z+α>L

x=h(f(n))=h(f(n−1))

Note that if a tolerance for jumping over the eHKDSr does not exist, the last write error position is taken.
c) f(n)>r2+z or r1>f(n)+s+z

x=h(f(n))=f(n)

Note that if there are no possibilities that the eHKDSf overlaps the eHKDSr, the ‘as-is’ state is taken.

Referring to FIG. 3 there is illustrated a routine 1000 for writing a first eHKDS, and second eHKDS key data to tape media using a method of computing the write start position. The method begins in block 1002.

In block 1002 the tape system is initialized. Processing then moves to block 1004.

In block 1004 the first eHKDS is written to the tape in the region between LP2 and LP3. In an exemplary embodiment for example and not limitation, the location of the first eHKDS between sections LP2 and LP3 can be determined based on previous calculations in block 1008 stored in memory and selected such that the first eHKDS does not overlap with a previously written first eHKDS and or second eHKDS.

In an exemplary embodiment as an example and not a limitation eHKDSr can be referred to as the first eHKDS, and eHKDSf can be referred to as the second eHKDS. Processing then moves to block 1006.

In block 1006 the write start and write end positions of the first eHKDS are stored in a memory after the first eHKDS is written. Processing then moves to block 1008.

In block 1008 the write start position of the second eHKDS is computed based on the positional information of the first eHKDS stored in memory from block 1006. In an exemplary embodiment, second eHKDS is dynamically calculated such that first eHKDS and second eHKDS do not overlap. In this regard, a vertical tape defect is less likely to damage both first eHKDS and second eHKDS. Processing then moves to block 1010.

In block 1010 the second eHKDS is written at the dynamically calculated write start position on the tape in the region between LP2 and LP3. The routine is then exited.

In an exemplary embodiment if an error occurs when the eHKDSf is written, the write start position may be shifted towards LP3. In contrast, if an error occurs when the eHKDSr is written, the write start position may be shifted towards LP2. In addition, a repetitive retry feature can be implemented. In this regard, the repetitive retry is useful for two reasons: prevention of a defect on the tape and verification of a write operation while slightly changing the hardware settings. As mentioned in the description of the computational expression, even when the end of the area is reached, the write operation is not stopped. Subsequently, a retry is attempted without shifting the write start position. In addition, when many errors occur, the timing when the end of the area is reached can be adjusted by slightly decreasing the length of shift of the write start position for the second eHKDS.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of computing a write start position of redundant data, said method comprising:
writing a first eHKDS on a tape media between said tape media sections LP2 and LP3;
storing in a memory a plurality of data related to a write start and write end position of said first eHKDS after said first eHKDS is written to said tape media; and
calculating based on said plurality of data a write start position of a second eHKDS between said tape media sections LP2 and LP3, such that said second eHKDS does not overlap said first eHKDS, wherein a vertical defect in said tape media is less likely to damage both said first eHKDS and said second eHKDS.

2. The method in accordance with claim 1, wherein said memory is a cartridge memory (CM).

3. The method in accordance with claim 1, wherein said memory is a nonvolatile memory.

4. The method in accordance with claim 1, further comprising:
dynamically determining the location of said first eHKDS based on the location of previously written said second eHKDS, such that said first eHKDS does not overlap the previously written said second eHKDS.

5. The method in accordance with claim 1, further comprising:
retrying repetitively write and verify operations while changing the hardware settings to prevent a defect on said tape media.

6. The method in accordance with claim 5, further comprising:
decreasing a length of shift of the write start position for subsequent said first eHKDS and said second eHKDS writes when errors occur.

7. A method of computing a write start position of redundant data, said method comprising:
dynamically determining a write location of a first eHKDS on a tape media between said tape media sections LP2 and LP3, such that said first eHKDS does not overlap a second eHKDS previously written;
writing said first eHKDS on said tape media between said tape media sections LP2 and LP3;
storing a plurality of data in a memory related to the write start and write end position of said first eHKDS after said first eHKDS is written to said tape media; and
calculating dynamically based on said plurality of data a write start position of said second eHKDS between sections LP2 and LP3, such that said second eHKDS does not overlap said first eHKDS, wherein a vertical defect in said tape media is less likely to damage both said first eHKDS and said second eHKDS.

8. The method in accordance with claim 7, wherein said memory is a cartridge memory (CM).

9. The method in accordance with claim 7, wherein said memory is a nonvolatile memory.

10. The method in accordance with claim 7, further comprising:
retrying repetitively write and verify operations while changing hardware settings to prevent a defect on said tape media.

11. The method in accordance with claim 10, further comprising:
decreasing the length of shift of the write start position for subsequent said first eHKDS and said second eHKDS writes when errors occur.
